(19) United States
(12) Patent Application Publication
(10) Pub. No.: US 2026/0033559 A1
(43) Pub. Date: Feb. 5, 2026

(54) GARMENT WITH SOLAR POWERED CHARGING

(71) Applicants: Jordan Christopher Walls, Seaford, DE (US); Stanton Jordan Ridley, Rockville Centre, NY (US); Daryl Riley, JR., Philadelphia, PA (US)

(72) Inventors: Jordan Christopher Walls, Seaford, DE (US); Stanton Jordan Ridley, Rockville Centre, NY (US); Daryl Riley, JR., Philadelphia, PA (US)

(21) Appl. No.: 18/793,690

(22) Filed: Aug. 2, 2024

(51) Int. Cl. A41D 1/00; H02S 10/40; H02S 30/20

(52) U.S. Cl. CPC A41D 1/005; H02S 10/40; H02S 30/20

(57) ABSTRACT

This invention is directed to a solar charging system for mobile electronic devices where the system is incorporated into a garment. The system includes a power management circuit that can receive power from flexible solar cells incorporated into the garment and provide wireless charging capabilities through a charging coil incorporated into a pocket of the garment. In one embodiment, strips of flexible solar cells are incorporated as design elements of the garment, such as a stripe pattern. In another embodiment, the system establishes a wireless connection to the device to receive information about the state of the battery of the mobile electronic device and to provide a status indicator of the battery state via a light incorporated into the garment.

### BACKGROUND

As mobile electronic devices become progressively more capable, these devices also consume an increasingly larger amount of electrical power. Users often find that charging is needed throughout a given day to meet the power demand of these devices. However, it is not always convenient for users to charge their mobile electronic devices at a stationary location.

One solution is to incorporate mobile charging capabilities into a jacket. Previous attempts resulted in jackets that are bulky and not very aesthetically pleasing. For example, some of these existing jackets incorporate large and rigid solar panels that are placed conspicuously in various parts of the jackets, thereby compromising the looks of those jackets. Also, the electronic components of these existing jackets typically require users to take multiple steps to properly use them, such as charging an onboard battery used for charging, plugging in and unplugging a device being charged, and taking out the device to monitor charging status. There is a need to provide a more user-friendly and convenient way for users to charge mobile devices while on the go.

### SUMMARY

This invention is directed to a solar charging system for mobile electronic devices where the system is incorporated into a garment. The system includes a power management circuit that can receive power from flexible solar cells incorporated into the garment and provide wireless charging capabilities through a charging coil incorporated into a pocket of the garment. In one embodiment, strips of flexible solar cells are incorporated as design elements of the garment, such as a stripe pattern. In another embodiment, the system establishes a wireless connection to the device to receive information about the state of the battery of the mobile electronic device and to provide a status indicator of the battery state via a light incorporated into the garment.

### BRIEF DESCRIPTION OF DRAWINGS

The Detailed Description is described with reference to the accompanying figures. In the description detailed herein, references are made to the accompanying drawings that form a part hereof, and that show, by way of illustration, specific embodiments or examples. The drawings herein are not drawn to scale. Like numerals represent like elements throughout the several figures.

FIG. 1 shows an exemplary solar-powered wireless charging system 100.

FIG. 2 shows exemplary electrical connections of a solar-powered wireless charging system.

FIG. 3 shows an exemplary component diagram of a solar-powered wireless charging system.

FIG. 4 shows an exemplary schematic circuit diagram of solar-powered wireless charging system.

### DETAILED DESCRIPTION

In the following detailed description, numerous specific details are set forth by way of examples in order to provide a thorough understanding of the relevant teachings. However, it should be apparent that the present teachings may be practiced without such details. In other instances, well-known methods, procedures, and/or components have been described at a relatively high level, without detail, in order to avoid unnecessarily obscuring aspects of the present teachings.

In creating this invention, the inventors want to provide a solar-powered wireless charging system for mobile electronic devices (such as smartphones) that can be incorporated into a garment, such as a jacket. A garment with the solar-powered wireless charging system as described herein would provide convenient charging capabilities and be easy to use, environmentally friendly, stylish and comfortable to wear.

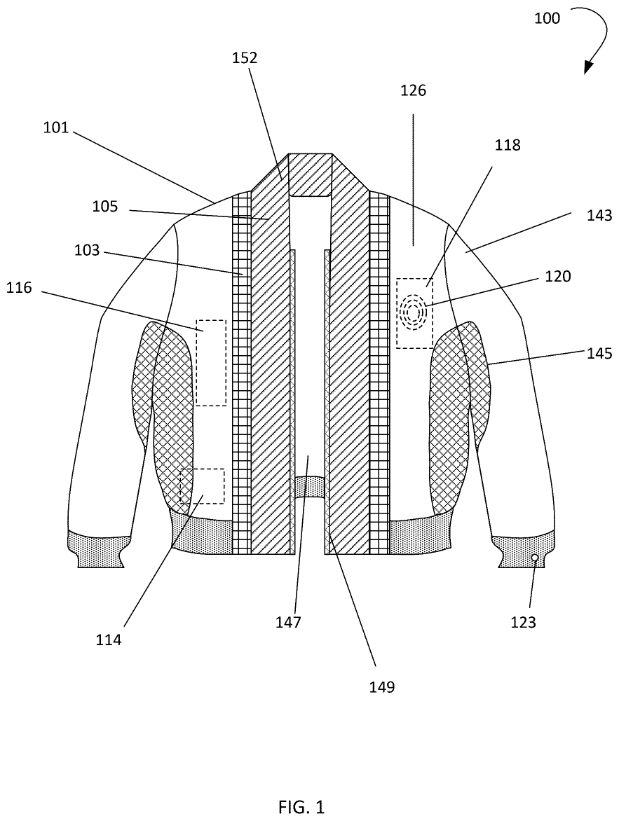

FIG. 1 shows an exemplary solar-powered wireless charging system 100. Jacket 101 is made from high-quality, lightweight, and durable materials. For example, outer layer 143 is a weather-resistant fabric that protects the internal electronic components from environmental factors such as moisture and temperature variations. An example of such fabric for outer layer is Ottertex 70D DWR Nylon Ripstop fabric. Inner layer 147 is made from a breathable, comfortable fabric to ensure case of wear. An example of such fabric for inner layer is nylon and Lycra fabric. Stretch layer 145 is made from a stretchable fabric that is breathable and resistant to wear. An example of such fabric is power mesh fabric with spandex and lightweight sheer. Jacket 101 includes strategically placed pocket 118 to house and align mobile electronic devices with the embedded charging coils 120. Pocket 118 is designed to securely hold a mobile electronic device while maintaining comfort and style. It is to be appreciated that multiple such pockets may be included in jacket 101.

Flexible solar cells 103 and 105 are integrated into the outer fabric of the jacket. These flexible solar cells are lightweight and conform to the shape of the garment, ensuring they do not interfere with the jacket's aesthetics or wearability. The solar cells are distributed across locations of the jacket with maximum exposure to sunlight and enhanced energy collection efficiency. In one embodiment, flexible solar cells 103 are shaped as strips and incorporated as an element of jacket 101. The strips of flexible solar cells 103 can have a high length to width aspect ratio, such as 5:1 to 30:1. In such manner, flexible solar cells 103 would appear as an integral design element (such as stripes) of jacket 101. In another embodiment, flexible solar cells 105 forms longitudinal parts for the zippers 149 as well as collar 152 of jacket 101. Flexible solar cells 103 and 105 provide an electric current when they are exposed to light. Flexible solar cells 103 and 105 can be implemented as flexible solar panels that are available on the market, such as Amorphous Silicon (a-Si), Polycrystalline Silicon (pc-Si), crystalline c-Si, Cadmium Telluride (CdTe), Organic Photovoltaics (OPV), Perovskite, Dye-Sensitized (DSSC), Copper Indium Gallium Selenide (CIGS), Quantum Dot, Thin Film, Nanocrystal, Hybrid, and Carbon-Based solar cells.

In one embodiment, flexible solar cells 103 and 105 is implemented as ultralight fabric solar cells, which are a type of solar cell that is exceptionally thin, lightweight, and flexible. These ultralight fabric solar cells are created using nanomaterials and can be integrated into fabrics, making them highly versatile for various applications. In another embodiment, flexible solar cells 103 and 105 is implemented as transparent solar cells composed of graphene, a highly conductive and flexible material.

Wireless charging coils 120 are embedded within the designated mobile electronic device pocket 118. The placement can be optimized to ensure effective power transfer when a mobile electronic device is placed in pocket 118. Wireless charging coils 120 can operate within standard wireless charging frequencies (typically around 110-205 kHz), ensuring compatibility with most mobile electronic devices. For example, Wireless charging coils may be controlled to operate in accordance with the Qi standard maintained by Wireless Power Consortium.

Solar-powered wireless charging system 100 includes power management circuit 114 and battery 116, which are fastened to jacket 101 in designated areas of jacket 101. Power management circuit 114 and battery 116 may be sewn into jacket 101 or in pockets that can be opened for removal and disassembly, as such as for the purpose of cleaning jacket 101. Power management circuit 114 is electrically connected to flexible solar cells 103 and 105, wireless charging coils 120, and battery 116. Power management circuit 114 regulates the power flow, for example from flexible solar cells 103 and 105 to battery 116 and from battery 116 to wireless charging coils 120. Major components include a voltage regulator, microcontroller, safety mechanisms (such as overcharge and thermal protection), and a battery management system. These components may be implemented as an integrated circuit and controlled by a processor of power management circuit 114. Battery 116 stores energy collected by flexible solar cells 103 and 105 and supplies power to charging coils 120. Battery 116 is rechargeable and may provide sufficient power to charge a mobile electronic device multiple times. Battery 116 may be implemented with many types of battery, such lithium ion, a super capacitor and the like.

Flexible solar cells 103 and 105 collect solar energy and convert it into electrical power. This power is routed through power management circuit 114, which regulates the voltage and current to charge mobile electronic devices and battery 116. Excess energy collected by flexible solar cells 103 and 105 can be stored in battery 116 for later use, ensuring that solar-powered wireless charging system 100 can charge mobile electronic devices even in low-light conditions or indoors.

When a mobile electronic device is placed in the designated pocket, wireless charging coils 120 align with the mobile electronic device's receiving coil. Power management circuit 114 activates the wireless charging function, transmitting power from flexible solar cells 103 and 105 and/or battery 116 through wireless charging coils 120 to the mobile electronic device. In this example, solar-powered wireless charging system 100 includes indicator light 123 that is controlled by power management circuit 114. Indicator light 123 may be located on the jacket collar, cuffs and other parts of jacket 101. Indicator light 123 may serve to notify the user of the charging status, providing real-time feedback, connectivity, and/or status of battery 116.

Power management circuit 114 may include safety features to prevent overheating, overcharging, and short circuits. For example, thermal sensors may monitor the temperature of the components, and the circuit automatically shuts down if unsafe conditions are detected. The system is designed to maximize charging efficiency, using algorithms to optimize power transfer and minimize energy loss.

A discreet control interface may be integrated into the jacket, allowing users to activate or deactivate the wireless charging function. This interface may include simple buttons or touch-sensitive areas on the surface of jacket 101.

Power management circuit 114 may include a Bluetooth module that enables wireless communication with the mobile electronic device. The Bluetooth module can be paired with a smartphone through the mobile electronic device's Bluetooth settings, following a pairing process.

Indicator light 123 may show the status of the Bluetooth connection, providing visual confirmation when solar-powered wireless charging system 100 is connected to a mobile electronic device. Power management circuit 114 may automatically detect when a compatible mobile electronic device is placed in the designated charging pocket 118 and initiates the wireless charging process. Indicator light 123 on jacket 101 may display the charging status of the smartphone, signaling when the phone is charging and when it is fully charged. Indicator light 123 may also be configured to show the battery level of battery 116, alerting the user when the battery needs to be recharged via solar power or an external power source.

To provide discreet notification, power management circuit 114 may include haptic feedback (e.g. vibration) to alert the user when mobile electronic device is fully charged or if there is an issue with the charging process. Indicator light 123 may also serve as visual alerts for various statuses, such as charging initiation, charging in progress, full charge, low battery, and Bluetooth connection status.

Jacket 101 may incorporate load bearing fabric 126 into parts of jacket 101 that holds components of solar-powered wireless charging system 100 such as charging coil 120, battery 116, and power management circuit 114. Load bearing fabric 126 can be fabric with favorable load bearing characteristics. Jacket 101 may include a layer of shielding fabric to shield against electromagnetic radiation for heath, privacy, safety, security or other reasons. An example of such layer is copper sleeve or metal mesh.

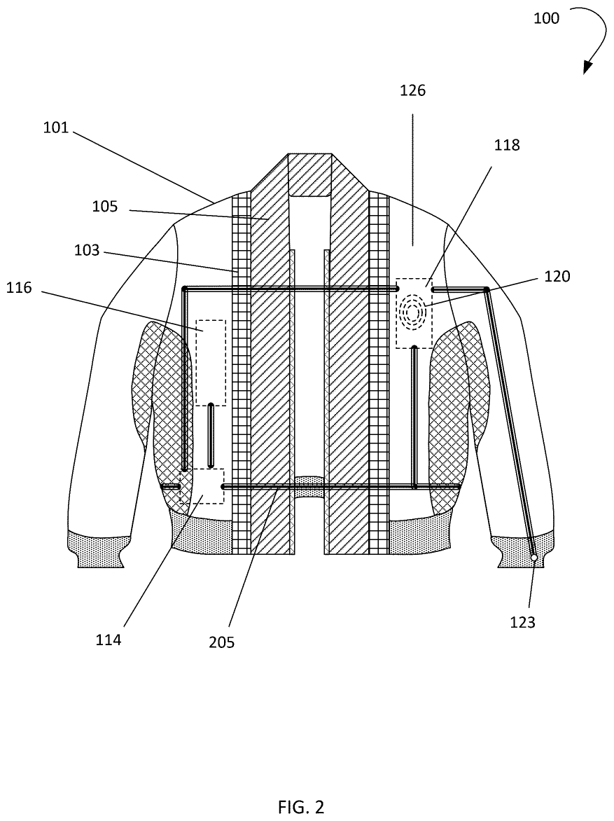

FIG. 2 shows exemplary electrical connections 205 of solar-powered wireless charging system 100. Flexible solar cells 103 and 105, charging coil 120, battery 116, and indicator light 123 are connected to power management circuit 114 with electrical connections 205. Electrical connections 205 may be implemented as any connections for electricity, such as wires and cables. In one embodiment, electrical connections 205 are implemented as conductive threads sewn into jacket 101 as part of the garment. Such implementation avoids protrusions that cause discomfort to the wearer of jacket 101. The use of conductive threads may also enable jacket 101 to be cleaned without the need to remove wires and cables. An example of conductive threads that can be used are Adafruit Stainless Medium Conductive Thread 641.

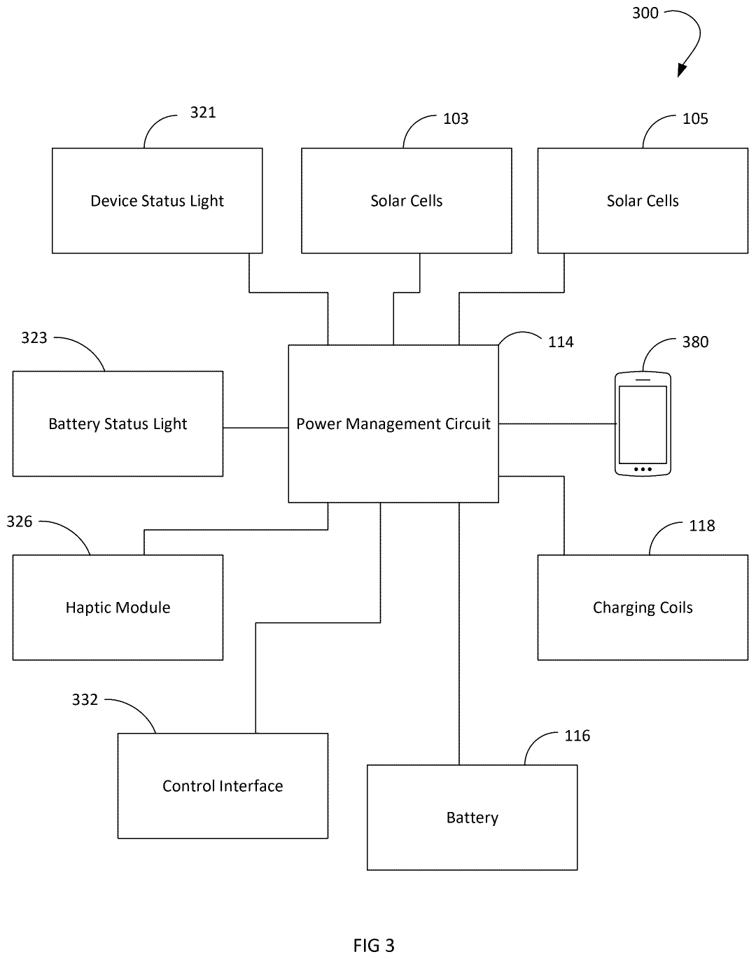

FIG. 3 shows an exemplary component diagram 300 of a solar-powered wireless charging system 100. Solar cells 103 and 105 are configured to generate electric current when exposed to light. Power management circuit 114 is configured to receive electric current from solar cells 103 and 105. Power management circuit 114 is configured to use the electric current to energize charging coils 118, which would charge mobile electronic device 380 when it is positioned over charging coils 118. Power management circuit 114 is also configured to manage the electric current by using the electric current from solar cells 103 and 105 to energize charging coils 118, using the electric current to charge battery 116, drawing electric current from battery 116 to energize charging coils 118, and a combination of these steps.

Power management circuit 114 is also configured to establish a wireless connection with mobile electronic device 380 and to receive information from the device through a wireless connection. This wireless communication can be implemented with any wireless frequency and protocol, such as Bluetooth, wifi, and NFC. The information can include states of mobile electronic device 380, such as state of charge of the device's battery, charging status, overcharging alerts, overheating alerts, wireless connection status, and the like.

In this embodiment, power management circuit 114 is connected to a device status light 321 and is configured to determine a status of device 380 and to control the illumination of device status light 321. For example, power management circuit 114 can control device status light 321 to turn on and off, blink, change color and change intensity based on status of device 380, such as device battery level, state of charge, connection status, alerts, and the like. Power management circuit 114 is also connected to battery status light 323 and is configured to control the illumination of battery status light 323. For example, power management circuit 114 can control battery status light 323 to turn on and off, blink, change color and change intensity based on status of battery 116, such as state of charge, battery level, alerts, and the like.

Power management circuit 114 is connected to haptic module 326 to provide feedback to the wearer, such as for the statuses of mobile electronic device 380 and battery 116 as described above. Haptic module 326 may be any electronic circuit that provides haptic feedback based on control signals and power, such as providing physical vibrations of varying frequency and intensity. Power management circuit 114 is also connected to control interface 332, which can communicate user input to power management circuit 114. Control interface 332 can be implemented as any microcontroller, such as an electronic or mechanical switch, a touch sensitive control, and the like. Control interface 332 may be integrated into a part of the garment to blend into the look of such garment. Control interface 332 may be configured to provide input to power management circuit 114 for a variety of functionalities, such as to activate or deactivate wireless charging functionality, establish wireless connectivity (e.g. Bluetooth pairing) with mobile electronic device 380, turn system power on or off, and the like.

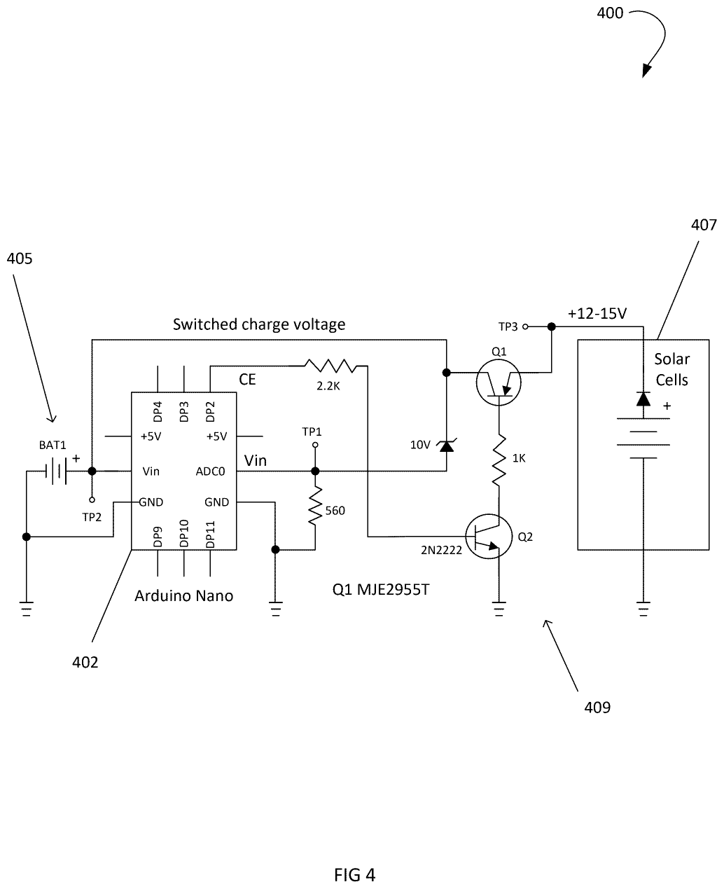

FIG. 4 shows an exemplary schematic circuit diagram 400 of a solar-powered wireless charging system 100. Any modern electronic processing modules can be used. In this example, Arduino Nano 402 is used and programmed to regulate the electric power from solar cells 407 and to charging coils and battery 405. As shown in FIG. 4, a voltage regulating circuit with transistors 409 is configured to convert electric current of 12 to 15 volts from solar cells to a lower voltage of around 5 volts for powering Arduino Nano 402. Arduino Nano 402 manages the charging process. It receives input from battery 405 and controls transistors 409 to regulate the voltage. MJE2955T and 2N2222 are both transistors that are used for switching the circuit on and off. Various resistors are used to set the biasing and control currents for the transistors. The 10V diode prevents backflow of current from the battery to the solar panel, protecting the panel and ensuring efficient charging.

It is to be appreciated that the solar-powered wireless charging system described herein eliminates the need for carrying extra cables and power banks, providing a seamless charging experience for smartphone users on the go. The components of solar-powered wireless charging system are integrated into a garment in a way that they do not detract from the aesthetic of the garment, which is a problem with existing smart clothing. By harnessing solar energy, jacket also promotes sustainable technology usage, reducing reliance on traditional power sources and contributing to environmental conservation.

An element proceeded by “a” or “an” does not, without further constraints, preclude the existence of additional identical elements in the process, method, article, or apparatus that comprises the element.

What is claimed is:

1. A system for charging a device in a garment comprising:
a power management circuit;
a strip of flexible solar cells incorporated as a part of the garment, the strip of flexible solar cells being electrically connected to the power management circuit;
a charging coil incorporated into a pocket of the garment, the charging coil being electrically connected to the power management circuit;
wherein the power management circuit is configured to receive electric current from the strip of flexible solar cells and to energize the charging coil to charge the device.

2. The system of claim 1, wherein the strip of flexible solar cells forms a design element of the garment.

3. The system of claim 1, wherein the strip of flexible solar cells forms at least a part of a collar of the garment.

4. The system of claim 1, wherein the strip of flexible solar cells is electrically connected to the power management circuit by conducting threads incorporated into the garment.

5. The system of claim 1, wherein the power management circuit is configured to establish a wireless connection with the device and to receive information from the device through the wireless connection.

6. The system of claim 5, wherein the wireless connection is at least one type of connections that include Bluetooth, wifi, and NFC.

7. The system of claim 5, wherein the information includes a state of battery of the device.

8. The system of claim 7, further comprising a device status light incorporated into the garment; wherein the device status light is electrically connected to the power management circuit and wherein the power management circuit controls illumination of the device status light based on the state of battery of the device.

9. The system of claim 1, further comprising a battery stored in the garment; wherein the power management circuit is configured to charge the battery with at least some of the electric current received from the strip of flexible solar cells and to determine a state of the battery.

10. The system of claim 9, further comprising a battery status light incorporated into the garment; wherein the battery status light is electrically connected to the power management circuit and wherein the power management circuit controls illumination of the battery status light based on the state of the battery.

11. The system of claim 1, wherein the garment is at least one type of a set that includes a jacket, a shirt, pants, a vest, a suit, a dress, shorts, and a coverall.

12. A jacket with solar powered charging capabilities comprising:
a strip of flexible solar cells incorporated as a part of the jacket;
a charging coil incorporated into a pocket of the jacket;
a power management circuit connected to the flexible solar cells and the charging coil;
wherein the power management circuit is configured to receive electric current from the strip of flexible solar cells and to energize the charging coil to charge a device.

13. The jacket of claim 12, wherein the pocket is configured to hold the device in a position that aligns with the charging coil.

14. The jacket of claim 12, further comprising a battery connected to the power management circuit and being configured to receive a charge from the power management circuit.

15. The jacket of claim 14, further comprising a charging port configured to receive electric current to charge the battery.

16. The jacket of claim 14, further comprising a battery status light incorporated into the jacket; wherein the power management circuit determines a state of the battery and controls illumination of the battery status light based on the state of the battery.

17. The jacket of claim 12, wherein the power management circuit is configured to establish a wireless connection with the device, to receive information from the device about a state of the device, and to controls illumination of the device status light based on the state of the device.

18. The jacket of claim 17, wherein the state of the device includes at least one type of states that include level of battery, charging status, Bluetooth connectivity status, and battery health status.

19. The jacket of claim 12, further comprising a microcontroller integrated into the jacket; wherein the microcontroller is configured to activate or deactivate wireless charging functionality of the power management circuit.

20. The jacket of claim 17, further comprising shielding fabric incorporated into the jacket to prevent electromagnetic interference among devices stored in the jacket.
